(19) United States
(12) Patent Application Publication
(10) Pub. No.: US 2006/0074778 A1
(43) Pub. Date: Apr. 6, 2006

(54) Apparatus and method for process managing

(75) Inventors: Yuusuke Katou, Tokyo (JP); Teruyoshi Aida, Mie (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/245,284

(22) Filed: Oct. 6, 2005

(30) Foreign Application Priority Data
Oct. 6, 2004 (JP) 2004-293283

(51) Int. Cl. G06F 9/46; G06F 19/00

(52) U.S. Cl. 705/28; 700/100; 705/8

(57) ABSTRACT

An apparatus for process management includes a unit that receives a planned number of a product to be produced on a production line operated by a tact system in a predetermined operating time. The unit calculates a plurality of delivery times included in the predetermined operating time, and the unit outputs instructions indicating that a part applied to the product is to be brought to the production line from the warehouse for use in a process of a plurality of processes which form the production line. Each of the plurality of delivery times indicates a planned time at which the part stored in the process runs out. The quantity of parts stored in each of the processes of the production line can be reduced because the parts are delivered at the time at which the previously stored parts run out.

### CROSS-REFERENCE TO RELATED APPLICATIONS

The present invention claims priority under 35 USC 119 based on Japanese patent application No. 2004-293283, filed on Oct. 6, 2004. The subject matter of these priority documents is incorporated by reference herein.

### BACKGROUND OF THE INVENTION

1. Field of the Invention

The present invention relates to a process management apparatus and a process management method. More specifically, the present invention relates to a process management apparatus and a process management method for calculating a schedule of a production line.

2. Description of the Related Art

To manufacture a product by an appointed day, process management for efficiently carrying parts that constitute the product is performed. FIG. 6 shows a factory where the process management is performed. The factory, shown in FIG. 6, is adapted to assemble a plurality of parts into a motor vehicle, and includes a production line 101 and a warehouse 102. The warehouse 102 is a facility for storing the parts. The parts are manufactured by customers 103 and carried to the warehouse 102 from the customers 103 by trucks 104.

The production line 101 includes a plurality of processes 106-1 to 106-n (where n=2, 3, 4 . . . ). The production line 101 forms a tact system including a conveyor that carries semi-manufactured vehicles, and configured so that the conveyor is stopped for a certain length of time, and when the certain length of time passes, all the vehicles stopped in respective processes 106-i (where i=1, 2, 3 . . . ) are carried to the next processes 106-(i+1). That is, the processes 106-1 to 106-n are equal in operating time pattern that indicates a plurality of time zones of a day in which each process operates.

Each process 106-i includes a line sidetrack space 107-i. The line sidetrack space 107-i stores the parts attached to a vehicle in the process 106-i. The warehouse 102 also includes tractors 108. Each tractor 108 carries parts 105 stored in the warehouse 102 from the warehouse 102 to the line sidetrack spaces 107-1 to 107-n.

The parts 105 should be carried from the warehouse 102 to the line sidetrack spaces 107-1 to 107-n in a number that is a multiple of a lot size set by the customers 103. According to conventional process management, a plurality of delivery time periods is appropriately set. Quantities of delivered parts to be delivered at the respective delivery time periods are then calculated. The quantity of parts to be delivered at each delivery time period is a multiple of the lot size, and is set to the quantity by which the parts are kept in the warehouse 102 until the next delivery time period.

FIG. 7 shows the total stock for the case in which conventional process management is performed. In FIG. 7, the total stock is expressed by a value on the vertical axis of the curve 141. It is desirable that the area of the line sidetrack space 17-i is minimized, and that the maximum quantity of the total stock is also minimized.

A stock interest, which means an interest burden caused by having the stock, is calculated according to the area of the region 142 surrounded by the curve 141 and the horizontal axis of the graph. As the area is increased, the stock interest is higher. It is desirable for the stock interest to be low.

Japanese Laid Open Patent Publication No. H10-151533 (1998) discloses a part delivery time period calculating method capable of more accurately calculating a delivery time period at which parts are delivered for use on an assembly line. The part delivery time period calculation method is a method for calculating a part delivery time period in which parts are delivered for use on the assembly line having different tact time according to a vehicle type from a part working line. The method is characterized by accumulating tact time periods for the number of vehicles produced per day with a maximum tact time in tact time periods of different vehicles present on the assembly line assumed as a tact time of the assembly line to thereby calculate a flow time of a day, dividing an operating time of a day by this flow time to thereby calculate a correction value, multiplying the tact time of each vehicle by this correction value to provide a corrected tact time, accumulating the corrected tact time periods and adding the accumulated value to an opening time, and calculating a delivery time at which a specific part is delivered the assembly line.

Japanese Laid Open Patent Publication No. H10-244445 (1998) discloses a part delivery indication method and a part delivery indication apparatus capable of automating an accurate, smooth, and appropriate delivery indication if it is necessary to issue a part preceding delivery indication. The part delivery indication method is a method for issuing a delivery indication for a specific part based on a production progress result at a specific position upstream of a utilization position at which the part is used. The position is determined according to a margin time required to deliver the part for the utilization position, characterized by including a preceding part calculation step of calculating a quantity of preceding parts according to a production status; and a correction step of correcting the specific position to be moved in a production line upstream direction by as much as the quantity of preceding parts.

Japanese Laid Open Patent Publication No. 2000-339015 (2000) discloses a dynamic part delivery indication system for a vehicle body factory capable of preventing a shortage of stock in vehicle body production processes and a warehouse, appropriately keeping the parts in stock, and improving operation rate and thereby greatly improving productivity. This is accomplished by calculating various pieces of data necessary to deliver parts based on vehicle type information and a dynamic production plan for each process in cooperation with the system during vehicle body production, and by providing equipment and supply personnel with part delivery information that enables delivering parts necessary for the processes at necessary time and at real time. The dynamic part input delivery system for the vehicle body factory is characterized by including: a materials host that provides logistics basic information, information on parts in stock, and information on parts; a management server that manages the dynamic part delivery indication and stock in processes and a warehouse based on the part information supplied from the materials host; a management system that collects and manages information on the dynamic part delivery indication, an online correction indication for the stock in the processes and the warehouse, and information on a process-specific vehicle type, and that manages results, a present status of pressing, and a present status of the vehicle body warehouse; and an on-board radio terminal device that informs completion of delivery of the parts over radio, corrects the stock in the processes and the warehouse, and refers to a present status of the stock.

### SUMMARY OF THE INVENTION

An object of the present invention is to provide an apparatus and a method for process management capable of efficiently supplying parts from a warehouse to each production line.

Another object of the present invention is to provide an apparatus and a method for process management capable of reducing a quantity of parts in stock for each process on a production line.

A further object of the present invention is to provide an apparatus and a method for process management capable of reducing a stock interest of parts in stock for each process on a production line.

In an aspect of the present invention, the apparatus for process management includes a number of production change registration unit that collects from an input unit a planned number of product to be produced on a production line operated by a tact system in a predetermined operating time. It also includes a delivery time calculation unit that calculates a plurality of delivery times included in the predetermined operating time, and a delivery instruction unit that outputs an instruction indicating that a part to be applied to the product is to be brought from a warehouse to a process that is included in a plurality of processes which form the production line. Each of the plurality of delivery times indicates a planned time that the part stored in the process will run out.

In another aspect of the present invention, a quantity of the parts delivered during each of the plurality of delivery times is constant.

In another aspect of the present invention, the apparatus for process management further includes a delivery quantity calculation unit that calculates a delivery quantity of the part delivered during each of the plurality of delivery times. A delivery quantity of the parts delivered to the process during a delivery time included in the plurality of delivery times is either a first quantity or a second quantity. The first quantity is calculated so that a first kind of part stored in the process runs out at a time that the part applied to the product in the process is changed from the first kind of part to a second kind of part. The second quantity is a constant value. The first quantity is smaller than the second quantity.

In another aspect of the present invention, the apparatus for process management further includes a delivery quantity calculation unit calculating a delivery quantity of a part delivered at each of the plurality of delivery times. The plurality of delivery times are calculated so that a quantity of the part just runs out when applied to the product in the process carried out during a period between two adjacent delivery times of the plurality of delivery times. In other words, a delivery quantity of the part delivered the process at a first delivery time of the plurality of delivery times is calculated so that the part stored in the process has run out at a second delivery time, the second delivery time being adjacent to the first delivery time in the plurality of delivery times. The instruction includes a delivery quantity of the part delivered at each of the plurality of delivery times.

In another aspect of the present invention, a method for process management includes the steps of: collecting a planned number of product to be produced on a production line in a predetermined operating time from an input unit, calculating a plurality of delivery times included in the predetermined operating time; and outputting an instruction indicating that a part applied to the product is to be brought in from a warehouse to a process in a plurality of processes which form the production line. Each of the plurality of delivery times indicates a planned time at which the part stored in the process is to run out.

In another aspect of the present invention, a quantity of the part delivered during each of the plurality of delivery times is constant.

In another aspect of the present invention, the method for process management further includes a step of calculating a delivery quantity of the parts delivered during each of the plurality of delivery times. A delivery quantity of the parts delivered to the process during a delivery time included in the plurality of delivery times is either a first quantity or a second quantity. The first quantity is calculated so that a first kind of part stored in the process is run out at a time that the part applied to the product in the process is changed from the first kind of part to a second kind of part. The second quantity is a constant value. The first quantity is smaller than the second quantity.

In another aspect of the present invention, the method for process management further includes a step of calculating a delivery quantity of a part delivered at each of the plurality of delivery times. The plurality of delivery times are calculated so that a quantity of the part just runs out when applied to the product in the process carried out during a period between two adjacent delivery times of the plurality of delivery times. A delivery quantity of the part delivered the process at a first delivery time of the plurality of delivery times is calculated so that the part stored in the process has run out at a second delivery time next to the first delivery time in the plurality of delivery times. The instruction includes a delivery quantity of the part delivered at each of the plurality of delivery times.

The apparatus and method for process management according to the present invention can reduce the quantity of parts in stock for each process on the production line.

### BRIEF DESCRIPTION OF THE DRAWINGS

FIG. 1 is a block diagram that depicts a factory to which a process management apparatus according to the present invention is applied;

FIG. 2 is a block diagram that depicts the process management apparatus according to one embodiment of the present invention;

FIG. 3 depicts an initial registration database;

FIG. 4 is a flowchart that depicts an operation for calculating a method for carrying parts;

FIG. 5 is a graph that depicts the total stock;

FIG. 6 is a block diagram that depicts a conventional factory; and

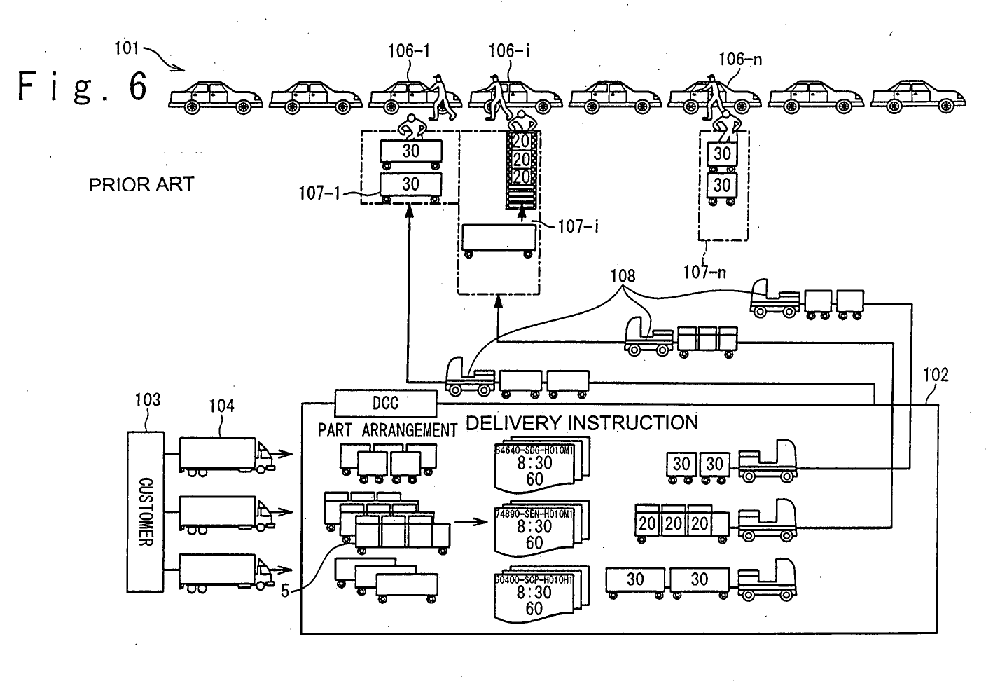

FIG. 7 is a graph that depicts the total stock when the factory is process-managed by a conventional method.

### DETAILED DESCRIPTION OF THE INVENTION

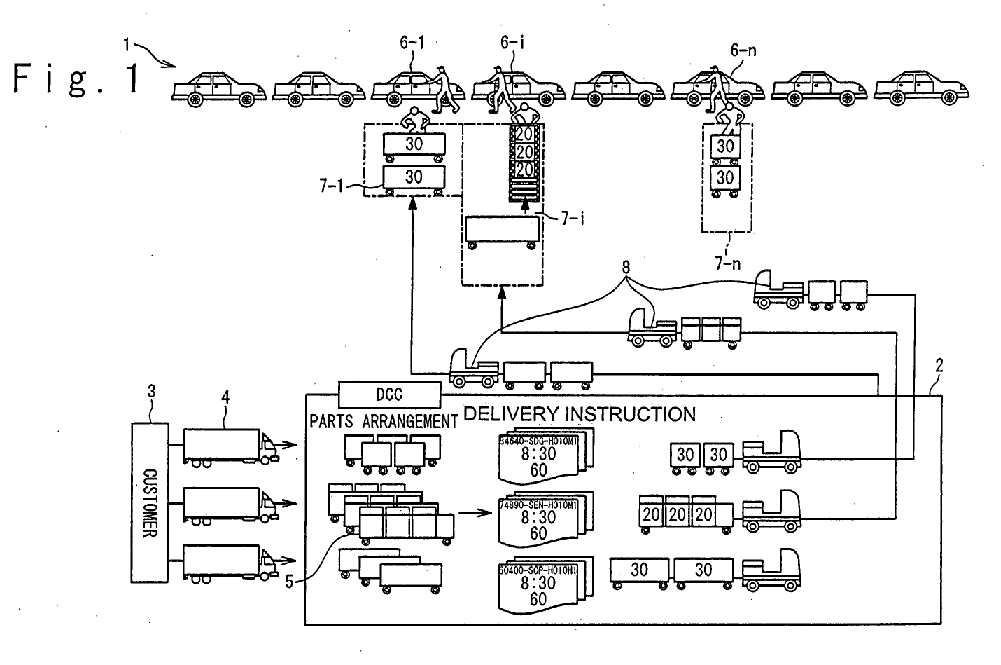

Referring to the drawings, a process management apparatus according to an embodiment of the present invention will be described. As shown in FIG. 1, a factory to which the process management apparatus is applied is adapted to assemble a plurality of parts into a motor vehicle and includes a production line 1 and a warehouse 2. The warehouse 2 is a facility for storing the parts. The parts are manufactured by customers 3 and carried from the customers 3 to the warehouse 2 by trucks 4.

The production line 1 includes a plurality of processes 6-1 to 6-n (where n=2, 3, 4 . . . ). The production line 1 forms a tact system that includes a conveyor for carrying semi-manufactured vehicles, and the tact system is configured so that the conveyor is stopped for certain length of time, and when the certain length of time passes, all vehicles stopped in respective processes 6-i are carried to next processes 6-(i+1). Namely, the processes 6-1 to 6-n are equal in an operating time pattern that indicates a plurality of time zones of a day in which each process operates.

Each process 6-i (i=1, 2, 3, . . . , n) includes a line sidetrack space 7-i. The line sidetrack space 7-i stores the parts to be attached to a vehicle in the process 6-i. The warehouse 2 also includes tractors 8. Each tractor 8 carries parts 5 stored in the warehouse 2 from the warehouse 2 to the line sidetrack spaces 7-1 to 7-n.

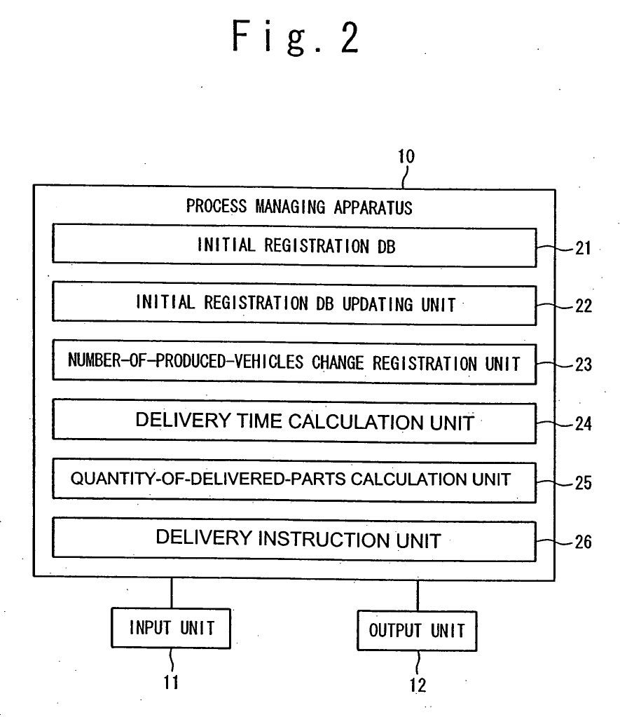

FIG. 2 shows a diagram which represents the process management apparatus according to this embodiment of the present invention. The process management apparatus 10 is an information processing device (namely, a computer) that includes an input unit 11 and an output unit 12 as well as a central processing unit (CPU) and a memory which are not shown in FIG. 2. The process management apparatus 10 is, for example, a workstation. The input unit 11, which is operated by a user, outputs information generated in response to the user's operation to the process management apparatus 10. The input unit 11 is, for example, a keyboard. The output unit 12, which is disposed in the warehouse 2, recognizably outputs information generated by the process management apparatus 10 to the user. The output unit 12, exemplified by a visual display, displays the information output from the process management apparatus 10. Alternatively, the output unit 12, exemplified by a printer, prints out the information output from the process management apparatus 10 on a paper sheet.

The process management apparatus 10 includes software including an initial registration database 21, and an initial registration database updating unit 22. The process management apparatus 10 also includes a number-of-produced-vehicles change registration unit 23, a delivery time calculation unit 24, a quantity-of-delivered-parts calculation unit 25 and a delivery instruction unit 26.

The initial registration database 21 records a table that indicates information on the parts 5 on a recording unit. The initial registration update unit 22 updates the table recorded by the initial registration database 21 based on information input to the input unit 11 by a user.

The number-of-produced-vehicles change registration unit 23 collects an operating time pattern of the production line 1 of a target day from the input unit 11, and collects the planned number of produced vehicles to be produced on the production line 1 on the target day. The delivery time calculation unit 24 calculates a plurality of delivery time periods for carrying the parts 5 from the warehouse 2 to the line sidetrack space 7-i based on the operating time pattern collected by the number-of-produced-vehicles change registration unit 23 and the planned the number of produced vehicles. The quantity-of-delivered-parts calculation unit 25 calculates quantities of the parts 5 to be carried from the warehouse 2 to the line sidetrack space 7-i at the respective delivery time periods calculated by the delivery time calculation unit 24.

The delivery instruction unit 26 generates a delivery instruction that indicates the delivery time periods calculated by the delivery time calculation unit 24 and the quantities of delivered parts calculated by the quantity-of-delivered-parts calculation unit 25. The delivery instruction unit 26 outputs the generated delivery instruction to the output unit 12.

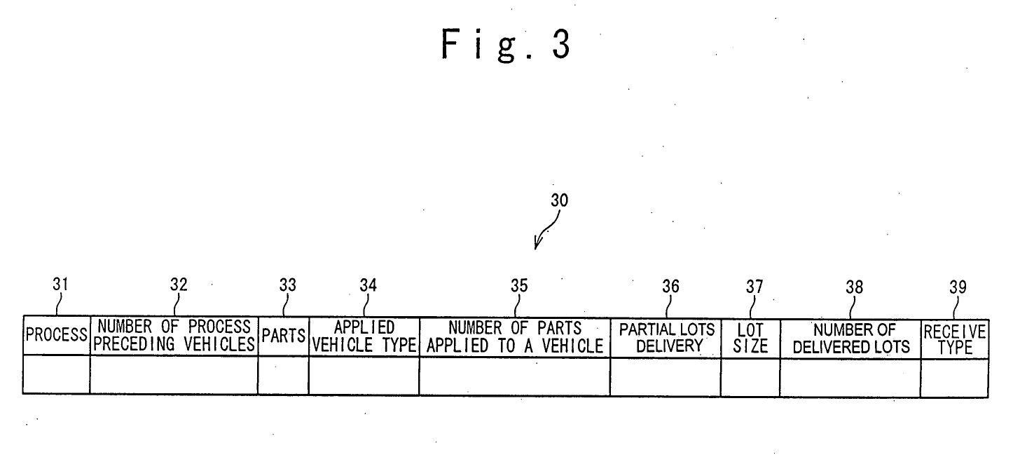

FIG. 3 shows the table recorded on the recording unit by the initial registration database 21. In the table 30, a process section 31 and the number of process preceding vehicles section 32 are associated with parts section 33. The parts section 33 provides a location for storing information for identifying the type of parts 5 and indicates the identification numbers of the parts 5. The process section 31 provides a location for storing information for identifying one process selected from the processes 6-1 to 6-n and in which the parts identified by the parts section 33 is consumed.

The number of process preceding vehicles section 32 indicates the number of vehicles arranged between the vehicles in the process identified by the process section 31 and the finished vehicles on the production line 1.

Further, in the table 30, an applied vehicle type section 34, the number of parts applied to a vehicle section 35, a partial lots delivery section 36, a lot size section 37, the number of delivered lots section 38, and a receive type section 39 are associated with the parts section 33. The applied vehicle type section 34 identifies a type of the vehicle to which the parts identified by the parts section 33 are attached, and indicates the vehicle type thereof. The number of parts applied to a vehicle section 35 indicates the number of parts applied to one vehicle of the type identified by the applied vehicle type section 34 and identified by the parts section 33.

The partial lots delivery section 36 indicates the conditions that the parts identified by the parts section 33 are delivered the line sidetrack space 7-i at one time, and shows either “partial lots delivery possible” and “partial lots delivery impossible”. The lot size section 37 is a value set by the customer 3 and indicates the quantity of the parts identified by the parts section 33 per lot. The number of delivered lots section 38 indicates the number of lots when the parts identified by the parts section 33 are delivered the line sidetrack space 7-i at one time. Namely, the parts identified by the parts section 33 are delivered the quantity indicated by the lot size section 37 in units of the quantity that is a multiple of the number of lots indicated by the number of delivered lots section 38.

Namely, when the partial lots delivery section 36 shows “partial lots delivery impossible”, the parts 5 are carried from the warehouse 2 to the line sidetrack space 7-i only in delivery units. If the partial lots delivery section 36 shows “partial lots delivery possible”, the parts 5 are carried from the warehouse 2 to the line sidetrack space 7-i in delivery units or in factions smaller than the delivery unit.

The receive type section 39 indicates an index for calculating a method for carrying the parts identified by the parts section 33, and shows either “lot preceding” or “time preceding”.

The delivery time calculation unit 24 calculates the tact time. The tact time is a quotient obtained by dividing the operating time of the production line 1 of the target day by the planned number of produced vehicles on the target day. Namely, the tact time indicates a time period for which one vehicle is produced on the production line 1, i.e., a time period required until the conveyor carries the vehicle to the next process 6-(i+1) after the vehicle is stopped in one process 6-i. The delivery time calculation unit 24 calculates a speed at which the process identified by the process section 31 consumes the parts identified by the parts 31 based on the tact time.

Referring to the initial registration database 21, if the receive type section 39 shows “lot preceding”, the delivery time calculation unit 24 divides the operating time of the target day into a plurality of time periods for which the process consumes the parts in delivery units. Referring to the operating time pattern of the target day, the delivery time calculation unit 24 calculates a time of dividing the operating time of the target day into a plurality of time periods, and sets a time adjusted from the calculated time by as much as the number of vehicles indicated by the number of process preceding vehicles section 32 as the delivery time.

Referring to the initial registration database 21, if the receive type of the parts shows “time preceding”, the delivery time calculation unit 24 divides the operating time of the target day generally equally into a plurality of time periods so that the quantity of the parts consumed in the process is smaller than a predetermined quantity. Referring to the operating time pattern of the target day, the delivery time calculation unit 24 calculates a time of dividing the operating time of the target day into a plurality of time periods, and sets a time adjusted from the calculated time by as much as the number of vehicles indicated by the number of process preceding vehicles section 32 as the delivery time.

Referring to the initial registration database 21, if the receive type section 39 of the parts shows “time preceding”, the quantity-of-delivered-parts calculation unit 25 sets the quantity of parts just consumed by the next delivery time as the quantity of delivered parts at the delivery time based on the speed calculated by the delivery time calculation unit 24 at which speed the process identified by the process section 31 consumes the parts.

Referring to the initial registration database 21, if the receive type section 39 shows “lot preceding” and the partial lots delivery section 36 shows “partial lots delivery impossible”, the quantity-of-delivered-parts calculation unit 25 sets the quantity of parts in the quantity indicated by the lot size section 37 only in delivery units of the quantity, which is a multiple of the number of lots indicated by the number of delivered lots section 38, as the quantity of the delivered parts.

Referring to the initial registration database 21, if the receive type section 39 shows “lot preceding”, the partial lots delivery section 36 shows “partial lots delivery possible”, and the type of vehicles produced on the production line 1 is not changed, the quantity-of-delivered-parts calculation unit 25 sets the quantity of parts only in delivery units of quantity as the quantity of the delivered parts.

Referring to the initial registration database 21, if the receive type section 39 shows “lot preceding” and the partial lots delivery section 36 shows “partial lots delivery possible”, the quantity-of-delivered-parts calculation unit 25 determines whether the process consumes the parts in delivery units by a changing time at which the type of produced vehicles is changed and at which the process consumes the other parts. If it is determined that the process consumes the parts in the delivery units, the quantity-of-delivered-parts calculation unit 25 sets the quantity of parts in delivery units as the quantity of delivered parts. If it is determined that the process does not consume the parts in the delivery units, the quantity-of-delivered-parts calculation unit 25 sets the quantity of parts calculated so that the parts are consumed just by the changing time, based on the speed calculated by the delivery time calculation unit 24. If the time for which the other parts are consumed is within a predetermined time or if the time the other parts are consumed is only a day after the former time, the quantity-of-delivered-parts calculation unit 25 can set the quantity of parts in delivery units as the quantity of delivered parts.

The process management method according to the embodiment of the present invention is executed by the process management apparatus 10. The method includes an operation of updating the table 30 and an operation of calculating the method for carrying parts.

In the operation of updating the table 30, at first, the user inputs information to be updated in the table 30 to the process management apparatus 10 using the input unit 11. Examples of the information to be updated include information on the delivery unit in which the parts are delivered, information as to whether the index for calculating the method for carrying parts is “lot preceding” or “time preceding”, and information as to whether the parts can be delivered fractions. The process management apparatus 10 updates the table 30 based on the input information.

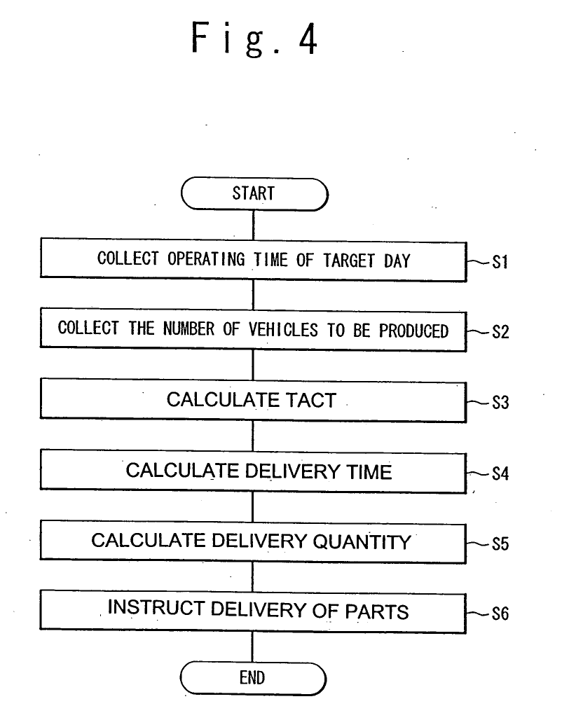

FIG. 4 is a flow diagram showing the operation of setting the method for carrying the parts by a calculation. In step S1, using the input unit 11, the user inputs the operating time pattern of a target day on which the process management is performed on delivery of the parts to the process management apparatus 10. Then, in step S2, using the input unit 11, the user inputs the planned number of produced vehicles to be produced at the target day to the process management apparatus 10. In step S3, the process management apparatus 10 divides the operating time of the production line 1 of the target day by the planned number of produced vehicles on the target day, thereby calculating the tact time, the tact time indicating the time for which one vehicle is produced on the production line. The process management apparatus 10 further calculates the speed at which the parts in the process 6-i are applied to the vehicles based on the tact time.

Referring to the initial registration database 21, in step S4, if the receive type section 39 indicates “lot preceding” and the partial lots delivery section 36 indicates “partial lots delivery impossible”, the process management apparatus 10 divides the operating time of the target day into a plurality of time periods at which the process consumes the parts in delivery units. The process management apparatus 10 calculates the time by dividing the operating time of the target day into a plurality of time periods, and sets the hour adjusted from the operating time pattern of the target day by as much as the number of vehicles indicated by the number of process preceding vehicles section 32 as the delivery time. Referring to the initial registration database 21, in the step S5, the process management apparatus 10 sets the quantity of parts in delivery units of the number, which is a multiple of the number of delivered lots of the lot size of the parts.

Referring to the initial registration database 21, in step S4, units if the receive type section 39 indicates “lot preceding” and the partial lots delivery section 36 indicates “partial lots delivery possible”, the process management apparatus 10 divides the operating time of the target day into a plurality of time periods at which the process consumes the parts in delivery units. The process management apparatus 10 calculates the hour by dividing the operating time of the target day into a plurality of time periods, and sets the time adjusted from the operating time pattern of the target day by as much as the number of vehicles indicated by the number of process preceding vehicles section 32 as the delivery time. The process management apparatus 10 determines whether the process consumes the parts in delivery units by the changing time at which the type of produced vehicles is changed and at which the process consumes the other parts. If it is determined that the process consumes the parts in the delivery units, at step S5 the process management apparatus 10 sets the quantity of parts in delivery units as the quantity of delivered parts. If it is determined that the process does not consume the parts in the delivery units, at step S5 the process management apparatus 10 sets the quantity of parts calculated so that the parts are consumed just by the changing time based on the speed calculated by the process management apparatus 10. If the time for which the other parts are consumed is within a predetermined time or if the time the other parts are consumed is only a day after the former time, the process management apparatus 10 can set the quantity of parts in delivery units as the quantity of delivered parts.

Referring to the initial registration database 21, at step S4, if the receive type of the parts is “time preceding”, the process management apparatus 10 divides the operating time of the target day generally equally into a plurality of time periods so that the quantity of the parts consumed in the process is smaller than the predetermined quantity. The process management apparatus 10 calculates the time of dividing the operating time of the target day into a plurality of time periods, and sets the time adjusted from the operating time pattern of the target day by as much as the number of vehicles indicated by the number of process preceding vehicles section 32 as the delivery time. At step S5, the process management apparatus 10 sets the quantity of parts just consumed by the next delivery time as the quantity of parts at the delivery time based on the speed at which the process consumes the parts. Such calculations of the delivery time and the quantity of delivered parts are executed, whether the parts can be delivered fractions or not.

In step S6, the process management apparatus 10 generates a list indicating the delivery time and the quantity of delivered parts calculated in the steps S4 and S5, respectively, and outputs the generated list using the output unit 12. An operator carries the parts 5 from the warehouse 2 to the line sidetrack spaces 7-1 to 7-n while referring to the list.

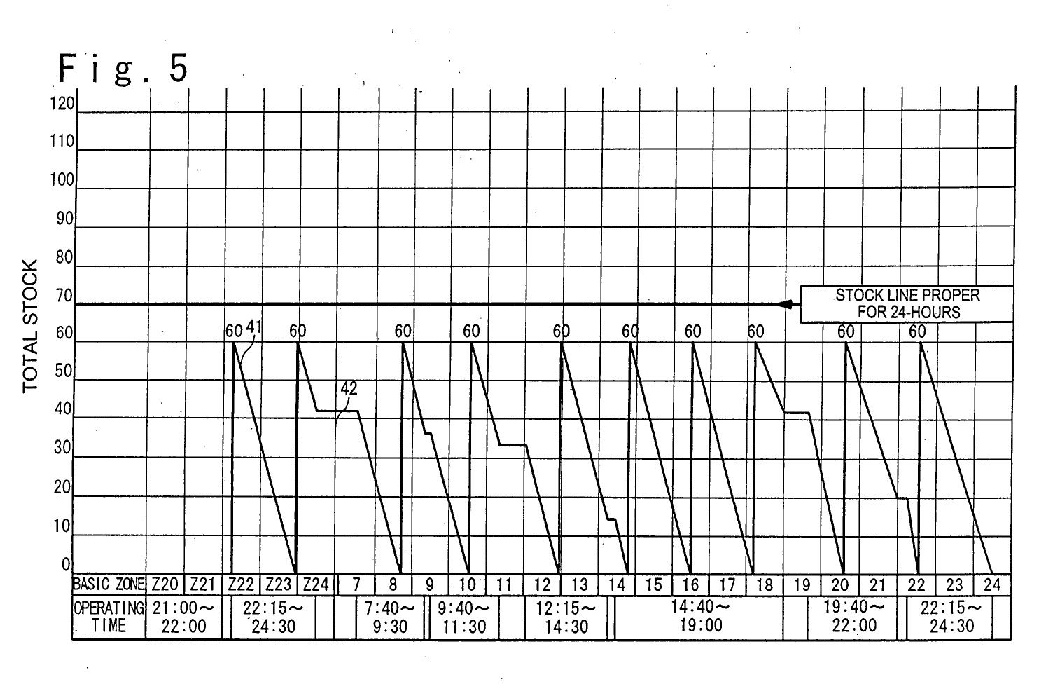

FIG. 5 shows the total stock of the parts in the line sidetrack space 7-i when the process management is performed by the process management method according to the embodiments of the present invention. Specifically, FIG. 5 shows the total stock of parts if the receive type of the parts is “lot preceding” and “partial lots delivery impossible” is shown in the partial lots delivery section 36. Namely, a graph of FIG. 5 includes a curve 41 and the total stock is expressed by the value on the vertical axis of the graph of the curve 41. The total stock can be made always smaller than a predetermined quantity by setting the delivery unit to be smaller than the quantity in the delivery unit. As a result, it is unnecessary for the line sidetrack space 7-i to keep the parts in stock larger in quantity than the predetermined quantity, thereby making it possible to design the line sidetrack space 7-i to be smaller in size.

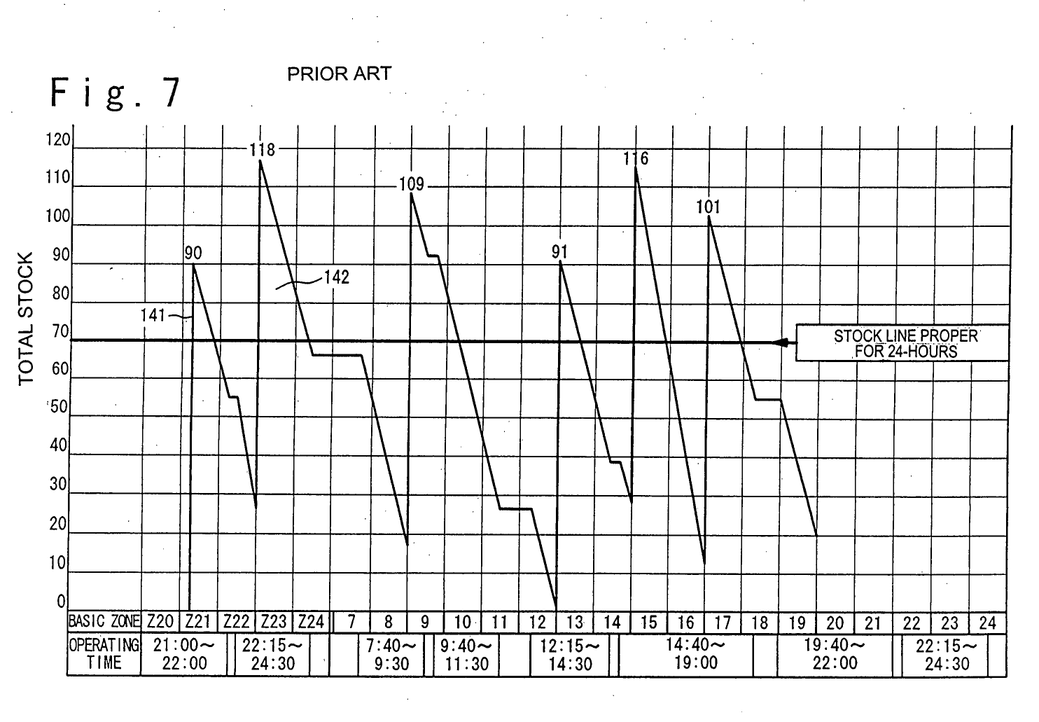

The stock interest indicates an interest burden based on the total stock. The stock interest is calculated according to the area of the region 42 surrounded by the curve 41 and the horizontal axis of the graph. As the area increases, the stock interest is higher. The stock interest when the process management is performed as shown in the flow of FIG. 4 is advantageously smaller than that when the total stock is changed as shown in FIG. 7.

The total stock can be made always smaller than the quantity in the delivery unit by setting the delivery unit to be smaller than the predetermined quantity similarly to the graph of FIG. 5 if the receive type of the parts is “lot preceding” and “partial lots delivery possible” is shown. If the type of produced vehicles is changed and the process is changed to consume the other parts, the smaller quantity of parts than the quantity in the delivery unit among the total stock are carried to the line sidetrack space 7-i. As a result, it is unnecessary for the line sidetrack space 7-i to keep the parts in stock larger in quantity than the quantity in the delivery unit, thereby making it possible to design the line sidetrack space 7-i to be smaller in size. Besides, the stock interest at this time is advantageously lower than the stock interest when the total stock is changed as shown in FIG. 7.

The total stock can be made always smaller than the predetermined quantity by dividing the operating time into a plurality of time periods so that the quantity of delivered parts is smaller than the predetermined quantity if the receive type of the parts is “time preceding”. As a result, it is unnecessary for the line sidetrack space 7-i to keep the parts in stock larger in quantity than the quantity in the delivery unit, thereby making it possible to design the line sidetrack space 7-i to be smaller in size. Besides, the stock interest at this time is advantageously lower than the stock interest when the total stock is changed as shown in FIG. 7.

While a working example of the present invention has been described above, the present invention is not limited to the working example described above, but various design alterations may be carried out without departing from the present invention as set forth in the claims.

What is claimed is:

1. An apparatus for process management comprising:
an input unit;
a number of product change registration unit which collects from the input unit a planned number of a product to be produced on a production line operated by a tact system in a predetermined operating time,
a delivery time calculation unit which calculates a plurality of delivery times included in said predetermined operating time; and
a delivery instruction unit which outputs an instruction indicating that a part to be applied to said product is to be brought from a warehouse for use in a process of a plurality of processes which form said production line,
wherein each of said plurality of delivery times indicates a planned time at which parts previously stored for use in said process have run out.

2. The apparatus for process management according to claim 1, wherein a quantity of said part delivered during each of said plurality of delivery times is constant.

3. The apparatus for process management according to claim 1, further comprising:
a delivery quantity calculation unit which calculates a delivery quantity of said part delivered during each of said plurality of delivery times,
wherein a delivery quantity of said part delivered to said process during a delivery time included in said plurality of delivery times is one of a first quantity and a second quantity,
said first quantity is calculated so that a first kind of part stored in said process runs out at a time that said part applied to said product in said process is changed from said first kind of part to a second kind of part,
said second quantity is a constant value, and
said first quantity is smaller than said second quantity.

4. The apparatus for process management according to claim 1, further comprising:
a delivery quantity calculation unit which calculates a delivery quantity of a part delivered at each of said plurality of delivery times,
wherein said plurality of delivery times are calculated so that a quantity of said part is applied to said product in said process carried out during a period between two adjacent delivery times of said plurality of delivery times,
a delivery quantity of said part delivered said process at a first delivery time of said plurality of delivery times is calculated so that said part stored in said process runs out at a second delivery time, the second delivery time being adjacent to said first delivery time in said plurality of delivery times, and
said instruction includes a delivery quantity of said part delivered at each of said plurality of delivery times.

5. A method for process management comprising steps of:
collecting from an input unit a planned number of product to be produced on a production line in a predetermined operating time,
calculating a plurality of delivery times included in said predetermined operating time; and
outputting an instruction indicating that a part to be applied to said product is to be brought from a warehouse to a process of a plurality of processes which form said production line,
wherein each of said plurality of delivery times indicates a planned time at which said part stored in said process is to run out.

6. The method for process management according to claim 5, wherein a quantity of said part delivered during each of said plurality of delivery times is constant.

7. The method for process management according to claim 5, further comprising:
a step of calculating a delivery quantity of said part delivered during each of said plurality of delivery times,
wherein a delivery quantity of said part delivered to said process during a delivery time included in said plurality of delivery times is one of a first quantity and a second quantity,
said first quantity is calculated so that a first kind of part stored in said process runs out at a time that said part applied to said product in said process is changed from said first kind of part to a second kind of part,
said second quantity is a constant value, and
said first quantity is smaller than said second quantity.

8. The method for process management according to claim 5, further comprising:
a step of calculating a delivery quantity of a part delivered at each of said plurality of delivery times,
wherein said plurality of delivery times are calculated so that a quantity of said part applied to said product in said process carried out during a period between two adjacent delivery times of said plurality of delivery times,
a delivery quantity of said part delivered said process at a first delivery time of said plurality of delivery times is calculated so that said part stored in said process runs out at a second delivery time, the second delivery time being adjacent to said first delivery time in said plurality of delivery times, and
said instruction includes a delivery quantity of said part delivered at each of said plurality of delivery times.

9. A computer program product comprising:
a computer usable medium having computer readable program code embodied therein configured for process management, comprising:
computer readable code configured to cause a computer to collect a planned number of product to be produced on a production line in a predetermined operating time from an input unit,
computer readable code configured to cause a computer to calculate a plurality of delivery times included in said predetermined operating time; and
computer readable code configured to cause a computer to output an instruction indicating that a part to be applied to said product is to be brought from a warehouse to a process of a plurality of processes which form said production line,
wherein each of said plurality of delivery times indicates a planned time that said part stored in said process is run out.

10. The computer program product according to claim 9, wherein a quantity of said part delivered during each of said plurality of delivery times is constant.

11. The computer program product according to claim 9, wherein said computer readable program code further comprises:
computer readable code configured to cause a computer to calculate a delivery quantity of said part delivered during each of said plurality of delivery times,
wherein a delivery quantity of said part delivered to said process during a delivery time included in said plurality of delivery times is one of a first quantity and a second quantity,
said first quantity is calculated so that a first kind of part stored in said process runs out at a time that said part applied to said product in said process is changed from said first kind of part to a second kind of part,
said second quantity is a constant value, and
said first quantity is smaller than said second quantity.

12. The computer program product according to claim 9, wherein said computer readable program code further comprises:
computer readable code configured to cause a computer to calculate a delivery quantity of a part delivered at each of said plurality of delivery times,
wherein said plurality of delivery times are calculated so that a quantity of said part is applied to said product in said process carried out during a period between two adjacent delivery times of said plurality of delivery times,
a delivery quantity of said part delivered said process at a first delivery time of said plurality of delivery times is calculated so that said part stored in said process runs out at a second delivery time, the second delivery time being next to said first delivery time in said plurality of delivery times, and
said instruction includes a delivery quantity of said part delivered at each of said plurality of delivery times.
